(19) United States
(12) Patent Application Publication
(10) Pub. No.: US 2010/0181403 A1
(43) Pub. Date: Jul. 22, 2010

(54) DRUM LINER ASSEMBLY FOR A MILL DRUM HAVING REPLACEABLE DRUM LINER SEGMENTS

(75) Inventor: Barry Kum, British Columbia (CA)

Correspondence Address: KENNAMETAL INC.;Intellectual Property Department, P.O. BOX 231, 1600 TECHNOLOGY WAY, LATROBE, PA, 15650, US

(73) Assignee: KENNAMETAL INC., Latrobe, PA (US)

(21) Appl. No.: 12/354,825

(22) Filed: Jan. 16, 2009

(51) Int. Cl. B02C 17/22; B02C 17/18

(52) U.S. Cl. 241/182; 241/300; 241/299

(57) ABSTRACT

An apparatus includes a mill drum for pulverizing and classifying material. The mill drum includes a cylindrical drum housing and one or more beater plates mounted for rotation within the housing. Each beater plate includes a plurality of beaters mounted on the peripheral edges thereof. A drum liner assembly includes a plurality of drum liner segments secured to the drum housing. Each drum liner segment includes a backing plate and one or more drum liners mounted thereon. The drum liners are made of a carbide material to provide superior wear characteristics.

### FIELD OF THE INVENTION

The invention relates in general to a classifier mill drum of the type in which material to be reduced in size is introduced into one end of a cylindrical housing and, by action of the horizontal axis pulverizing and classifying rotors, is progressively reduced in size, and in particular to a classifier mill drum with replaceable drum liner elements made of carbide material for superior wear characteristics.

### BACKGROUND OF THE INVENTION

Typically, classifier drum mills consist of a large cylindrical drum which is rotated about a horizontal axis. At least one axial end of the drum is open, and the material to be comminuted is continuously fed into the mill with the comminuted product continuously emerging from the drum mill.

Many materials that are pulverized and classified by the drum mill are extremely hard and highly abrasive. In order to maintain continuous operation of the grinding mill, it is necessary to provide a wear liner for the drum that is highly abrasion-resistant, and which also is tough enough to withstand the continuous impact of material fragments. Some drum mills may also employ rods or balls to assist in the comminuting process, which further compounds the problem of wear.

Most drum liners are typically constructed from a plurality of drum liner segments that may be aligned both axially and circumferentially on the inner surface of the drum shell. Often, removal of the liner segments takes considerably more time than their installation, resulting in substantial down time of the processing plant. This has serious economic effects because it is economically desirable that processing plants operate 24 hours a day, 7 days a week. Therefore, it is desirable to provide drum liner segments that have superior wear characteristics, thereby increasing the productivity of the processing plant.

### SUMMARY OF THE INVENTION

In one aspect of the invention, a mill drum for a pulverizing and classifying apparatus comprises a cylindrical drum housing; one or more beater plates mounted for rotation within the housing, each beater plate including a plurality of beaters mounted on the peripheral edges thereof; and a drum liner assembly comprising a plurality of drum liner segments secured to the drum housing, each drum liner segment comprising a backing plate and one or more drum liners mounted thereon, wherein the drum liners are made of carbide material.

In another aspect of the invention, a removable drum liner assembly for a drum housing of a pulverizing and classifying apparatus comprises a plurality of drum liner segments secured to a drum housing of the pulverizing and classifying apparatus, each drum liner segment comprising a backing plate and one or more drum liners mounted thereon, wherein the drum liners are made of carbide material.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is an elevation view, partly in section, of a mill drum with replaceable liner elements according to an embodiment of the invention;

FIG. 2 is a cross-sectional view of the mill drum taken along line 2-2 of FIG. 1;

FIG. 3 is a front elevation view of a drum liner assembly according to an embodiment of the invention;

FIG. 4 is a side view of the drum liner assembly of FIG. 3;

FIG. 5 is a front elevation view of a backing plate according to an embodiment of the invention;

FIG. 6 is a cross-sectional view of the backing plate of FIG. 5 taken along line 6-6;

FIG. 7 is a front elevation view of a liner segment according to an embodiment of the invention; and

FIG. 8 is a cross-sectional view of the liner segment of FIG. 7 taken along line 8-8.

### DETAILED DESCRIPTION OF THE INVENTION

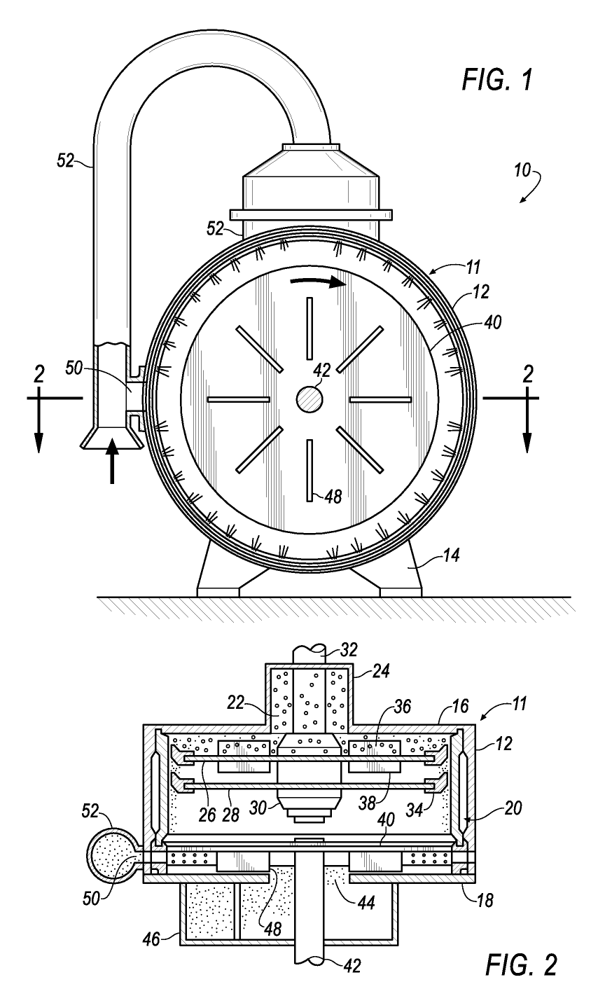

Referring now to FIGS. 1 and 2, a pulverizing and classifying apparatus is shown generally at 10. The apparatus 10 comprises a mill drum 11 that includes a cylindrical drum housing 12 supported, for example, on feet or legs 14. The drum housing 12 has end walls 16 and 18 and, as shown, preferably has a removable drum liner assembly 20 in accordance with the invention. The end wall 16 has an inlet opening 22 located in the central portion thereof. The inlet opening 22 communicates with a hopper 24 through which material to be ground is fed and through which tailings are recycled for further reduction.

One or more discs or circular beater plates 26, 28 are mounted on a hub 30 and a shaft 32 for rotation within the housing 12. Each beater plate 26, 28 carries a plurality of spaced beaters 34 mounted on the peripheral edges thereof. The beater plate 26 closest to the inlet opening 22 carries a plurality of radiating primary beater vanes or angles 36 spaced radially inwardly from the beaters 34 and mounted on the feed inlet side of the plate 26. The edges of the beater vanes 36 are closely spaced from the end wall 16 and in cooperation therewith perform a primary size reduction of the material to be ground. The opposite side of beater plate 26 carries a plurality of similar secondary beater vanes or angles 38 that serve to balance the beater plate 26 and to assist in performing the pulverizing function in conjunction with the next adjacent beater plate 28.

A classifier disc 40 is mounted on a shaft 42 that extends through an outlet or discharge aperture 44 in the end wall 18. The shaft 42 is substantially coaxial with the shaft 32. The aperture 44 communicates directly with a scroll housing 46 for removal of the desired pulverized product. A plurality of radial classifying vanes 48 are mounted on the discharge side of classifier disc 40.

The drum housing 12 is provided with a tailings port or aperture 50 adjacent the periphery of classifier disc 40 in the classifying zone for withdrawal of the tailings, those particles not reduced to the desired particle size. These tailings are withdrawn through the aperture 50 and may be recycled through a duct 52 for further pulverizing.

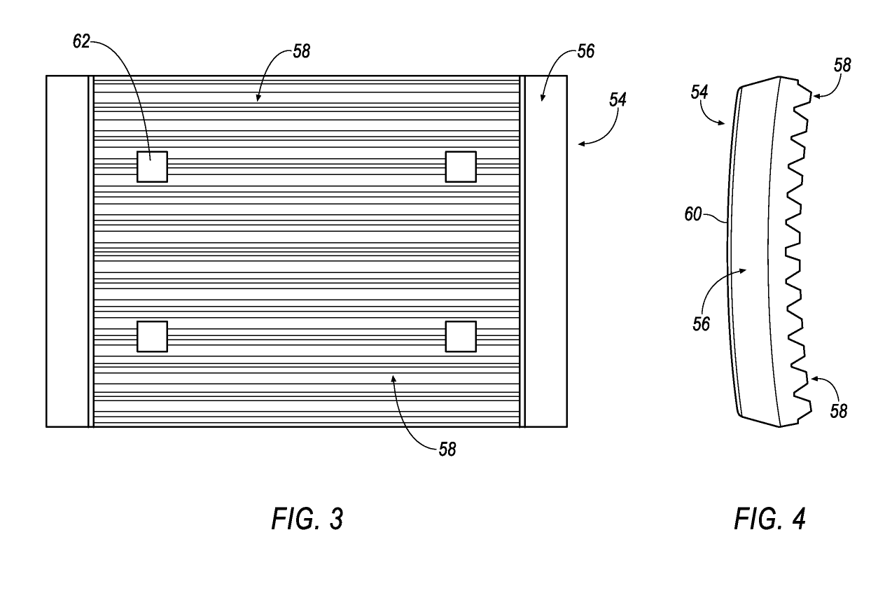

Referring now to FIGS. 3-8, the drum liner assembly 20 comprises a plurality of individual drum liner segments 54 the are secured to the drum housing 12 and cover virtually the entirety of its inner cylindrical surface. In one embodiment, the drum liner segments 54 are arranged in longitudinal rows that are disposed in alignment with the rotational axis of the shafts 32, 42. In another embodiment, the drum liner segments 54 are also arranged in circumferential rows, longitudinal rows, or both.

As seen in FIGS. 3 and 4, each drum liner segment 54 comprises a backing plate 56 and one or more drum liners 58 mounted thereon. Each of the drum liner segments 54 has a mounting surface 60 that is slightly curved to conform to the inner cylindrical surface of the drum housing 12, such curvature being exaggerated in FIG. 4 for purposes of clarity.

Each drum liner segment 54 is formed with at least two mounting openings 62 that are registrable with corresponding mounting openings in the drum housing 12 to receiving nut and bolt assemblies (not shown). It will be realized that the mounting openings 62 of the backing plate 56 and the one or more drum liners 58 are aligned when the one or more drum liners 58 are properly mounted on the backing plate 56. The details of the structure and cooperative function of the nut and bolt assemblies with the mounting openings 62 are well-known in the art and do not constitute a part of this invention. The nut and bolt assemblies allow each drum liner segment 54 to be removed from the drum housing 12 and replaced when worn.

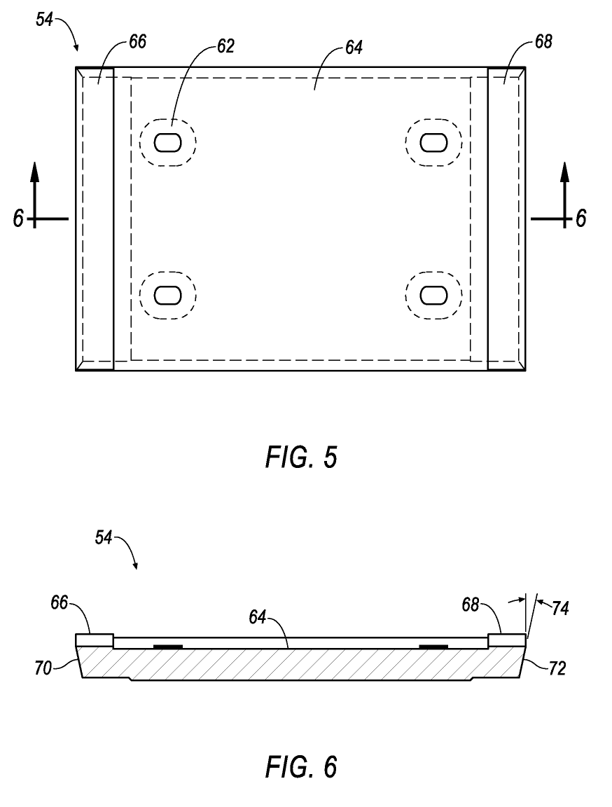

Referring now to FIGS. 5 and 6, the backing plate 56 includes a recessed central portion 64 capable of receiving the one or more drum liners 58 therein. The backing plate 56 also includes a pair of opposing side portions 66, 68 that act as a support for the drum liners 58 to prevent their unwanted linear movement. The backing plate 56 has a pair of tapered side walls 70, 72 that are formed at an angle 74 with respect to a plane perpendicular to the recessed central portion 64. As mentioned earlier, the backing plate 56 has a mounting surface 60 (FIG. 4) that is slightly curved to conform to the inner cylindrical surface of the drum housing 12.

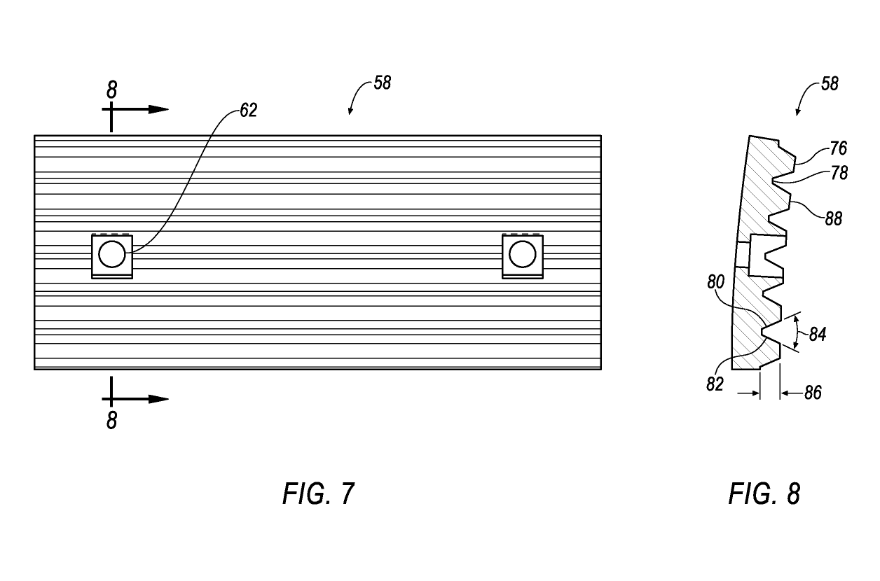

Referring now to FIGS. 7 and 8, each drum liner 58 has a plurality of teeth 76 for pulverizing and classifying the material fed into the apparatus 10. The teeth 76 are separated from each other by a groove 78 defined by a pair of opposing tapered side walls 80, 82 formed at an angle 84 with respect to each other. In one embodiment, the angle 84 is in a range between about 30 degrees and about 60 degrees. In the illustrated embodiment, the angle 84 is about 45 degrees. However, it will be appreciated that the invention is not limited by the angle 84, and that the invention can be practiced by using any desirable angle, depending on the particular application of the apparatus 10.

Each tooth 76 is formed at a height 86 and with a substantially planar top surface 88. Thus, each tooth 76 is shaped similar to a truncated cone. In one embodiment, the height 86 of the tooth 76 is in a range between about 0.10 inches (2.54 mm) to about 0.40 inches (10.16 mm). In the illustrated embodiment, the height 86 is about 0.25 inches (6.35 mm). However, it will be appreciated that the invention is not limited by the height 86, and that the invention can be practiced by using any desirable height, depending on the particular application of the apparatus 10.

Conventional liner segments ultimately become worn during the comminuting process and require replacement. As mentioned earlier, premature wear and replacement of conventional liner segments greatly reduces productivity of the processing plant. One aspect of the invention is that the drum liners 58 are made of a carbide material. In one embodiment, the carbide material comprises about 8-9% cobalt, about 4.5-6.5% tantalum, about 5-7% titanium and about 2-3% niobium.

Production data has demonstrated the unexpected results that the drum liners 58 of the invention provide superior wear characteristics, as compared to conventional liner segments made of a different material, such as ceramic, and the like. Ceramic liners processed 400,000 pounds of material before having to index the liner to the other side. In total, a ceramic liner was replaced after 800,000 pounds of material. During the test, carbide liners of the invention with about 8.5% cobalt by weight processed over 1.8 million pounds of material without any signs of wear and the need to index to the other side.

The patents and publications referred to herein are hereby incorporated by reference.

Having described presently preferred embodiments the invention may be otherwise embodied within the scope of the appended claims.

What is claimed is:

1. A mill drum for a pulverizing and classifying apparatus, comprising:
a cylindrical drum housing;
one or more beater plates mounted for rotation within the housing, each beater plate including a plurality of beaters mounted on the peripheral edges thereof; and
a drum liner assembly comprising a plurality of drum liner segments secured to the drum housing, each drum liner segment comprising a backing plate and one or more drum liners mounted thereon, wherein the drum liners are made of carbide material.

2. The mill drum according to claim 1, wherein the one or more drum liners includes a plurality of teeth separating by a groove, each tooth having a substantially planar top surface.

3. The mill drum according to claim 2, wherein each tooth has a height in a range between about 0.10 inches and about 0.40 inches.

4. The mill drum according to claim 2, wherein each tooth is formed by a pair of opposing tapered side walls having an angle in a range between about 30 degrees and about 60 degrees.

5. The mill drum according to claim 1, wherein the backing plate includes a recessed central portion capable of receiving the one or more drum liners therein, and a pair of opposing side portions that act as a support for the one or more drum liners.

6. The mill drum according to claim 1, wherein the carbide material comprises about 8-9% cobalt, about 4.5-6.5% tantalum, about 5-7% titanium and about 2-3% niobium.

7. A removable drum liner assembly for a drum housing of a pulverizing and classifying apparatus, comprising:
a plurality of drum liner segments secured to a drum housing of the pulverizing and classifying apparatus, each drum liner segment comprising a backing plate and one or more drum liners mounted thereon, wherein the drum liners are made of carbide material.

8. The drum liner assembly according to claim 7, wherein the one or more drum liners includes a plurality of teeth separating by a groove, each tooth having a substantially planar top surface.

9. The drum liner assembly according to claim 8, wherein each tooth has a height in a range between about 0.10 inches and about 0.40 inches.

10. The drum liner assembly according to claim 8, wherein each tooth is formed by a pair of opposing tapered side walls having an angle in a range between about 30 degrees and about 60 degrees.

11. The drum liner assembly according to claim 7, wherein the backing plate includes a recessed central portion capable of receiving the one or more drum liners therein, and a pair of opposing side portions that act as a support for the one or more drum liners.

12. The drum liner assembly according to claim 7, wherein the carbide material comprises about 8-9% cobalt, about 4.5-6.5% tantalum, about 5-7% titanium and about 2-3% niobium.
